(19) United States
(12) Patent Application Publication
(10) Pub. No.: US 2020/0288915 A1
(43) Pub. Date: Sep. 17, 2020

(54) Shaker

(71) Applicant: Cool Gear International, LLC, Plymouth, MA (US)

(72) Inventor: Tyler Noveletsky, North Easton, MA (US)

(73) Assignee: Cool Gear International, LLC, Plymouth, MA (US)

(21) Appl. No.: 16/082,081

(22) PCT Filed: Mar. 3, 2017
(86) PCT No.: PCT/US17/20599

§ 371 Date: Sep. 4, 2018

Related U.S. Application Data
(60) Provisional application No. 62/304,067, filed on Mar. 4, 2016.

(51) Int. Cl. A47J 43/27; B01F 13/00

(52) U.S. Cl. CPC A47J 43/27; B01F 13/005; B01F 13/0022

(57) ABSTRACT

The present disclosure relates to a bottle for storing a beverage powder, dispensing the beverage powder into a liquid, and thoroughly mixing the dispensed powder into the liquid.

### RELATED APPLICATIONS

This application is a national stage entry, filed under 35 U.S.C. § 371, of International Application No. PCT/US2017/020599, filed on Mar. 3, 2017, which claims the benefit of priority under 35 U.S.C. § 119(e) to U.S. Provisional Application No. 62/304,067, filed on Mar. 4, 2016 in the U.S. Patent and Trademark Office, the entire contents of each of which are hereby incorporated herein by reference in their entireties.

### FIELD OF THE DISCLOSURE

The present invention relates to a bottle for dispensing a powder based beverage. More particularly, the present invention relates to a bottle for storing a beverage powder, dispensing the beverage powder into a liquid, and thoroughly mixing the dispensed powder into the liquid.

### BACKGROUND

Recently, there has been a rise in the popularity of many types of beverages made from a dry powder mix. For example, many varieties of powdered supplements are available that may be added to a fluid (e.g., water, mineral water, beer, etc.) to form a convenient and nutritious drink or shake. Such beverages are particularly popular with athletes, people recovering from injuries, and people pursuing a vegan or vegetarian lifestyle. Such powdered supplements may include meal replacement powders, nutritional additives, and protein supplements. Protein supplements generally should not be mixed ahead of time, as the protein may denature in the water over time and if not properly stored, may promote the growth of harmful bacteria. Shaking powdered mixes (e.g., supplements, protein shake mixes, etc.) using traditional water bottles often results in the presence of residual clumps of powder that prevent the formation of a uniformly mixed drink. Accordingly, there is a need for improved beverage containers that facilitate the production of a uniformly mixed beverage created from a dry powder mix and a fluid.

### SUMMARY

The present disclosure relates to a bottle for storing a beverage powder, dispensing the beverage powder into a liquid, and thoroughly mixing the dispensed powder into the liquid.

In one aspect, a mixing container as disclosed herein may include a bottle; and a cap assembly mechanism that includes a spout mounted on a top portion of the cap assembly mechanism, a chamber positioned within the cap assembly mechanism having a chamber top position and a chamber bottom position, wherein the chamber bottom position includes a chamber opening, a dial mounted on the top portion of the cap assembly mechanism and positioned proximate to the chamber top position, an agitator retaining post having a first end and a second end, and an agitator configured to mate with the chamber opening, wherein the first end of the agitator retaining post is configured to be attached to a bottom portion of the dial, and the second end of the agitator retaining post is configured to reversibly engage the agitator.

In an embodiment, the agitator seals the chamber when engaged with the second end of the agitator retaining post and mated with the chamber opening.

In an embodiment, the agitator deploys into the bottle when not engaged with the second end of the agitator retaining post, thereby allowing powdered contents of the chamber to come into contact with a fluid in the bottle.

In an embodiment, the deployed agitator mixes the powdered contents into the fluid when the container is shaken.

In an embodiment, the cap assembly mechanism further comprises a strap and a, wherein the strap is configured to mate with an upper portion of the cap.

In an embodiment, a bottom portion of the chamber opening includes an agitator gasket.

In an embodiment, the chamber opening is positioned within a chamber plate that forms the chamber bottom position.

In an embodiment, the chamber plate is configured to be hingedly connected to the cap assembly mechanism.

In an embodiment, the chamber plate includes a latch configured to reversibly couple with a catch positioned on the cap assembly mechanism.

In an embodiment, the agitator includes a plurality of raised ribs positioned vertically around the circumference of the agitator.

In one aspect, the disclosure provides a method of mixing a powder based drink in the above mixing container by placing a powder in the chamber; engaging the agitator with the agitator retaining post; filling the container with a fluid; releasing the powder into the container by turning the dial to disengage the agitator from the agitator retaining post; and shaking the container so that the released agitator thoroughly mixes the powder with the fluid.

### BRIEF DESCRIPTION OF THE DRAWINGS

For a fuller understanding of the nature and desired objects of the present disclosure, reference is made to the following detailed description taken in conjunction with the following figures wherein:

FIG. 1A is an overview of a bottle for storing and dispensing a powder based beverage according to an exemplary embodiment of the present disclosure;

FIG. 1B is front view of a bottle for storing and dispensing a powder based beverage according to an exemplary embodiment of the present disclosure;

FIG. 1C is a side view of a bottle for storing and dispensing a powder based beverage according to an exemplary embodiment of the present disclosure;

FIG. 1D is a top view of a bottle for storing and dispensing a powder based beverage according to an exemplary embodiment of the present disclosure;

FIG. 2 is a cross-sectional view of a bottle for storing and dispensing a powder based beverage according to an exemplary embodiment of the present disclosure;

FIG. 3 is cross-sectional view of a bottle for storing and dispensing a powder based beverage in which an agitator has been deployed according to an exemplary embodiment of the present disclosure;

FIG. 4 is a bottom perspective view of a cap assembly mechanism in an open position according to an exemplary embodiment of the present disclosure;

FIG. 5 is a bottom perspective view of a cap assembly mechanism in a closed position according to an exemplary embodiment of the present disclosure;

FIG. 6 is a bottom perspective view of a cap assembly mechanism and agitator in a deployed position according to an exemplary embodiment of the present disclosure;

FIG. 7 is an inverted view of a cap assembly mechanism and agitator in a sealed position according to an exemplary embodiment of the present disclosure;

FIG. 8 is an exploded view of a cap assembly mechanism according to an exemplary embodiment of the present disclosure; and

FIG. 9 shows various views of an agitator according to an exemplary embodiment of the present disclosure;

### DETAILED DESCRIPTION

Hereinafter reference will now be made in detail to various exemplary embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to limit the invention. The instant disclosure is most clearly understood with reference to the following definitions:

As used in the specification and claims, the singular form “a,” “an,” and “the” include plural references unless the context clearly dictates otherwise.

As used in the specification and claims, the terms “comprise(s),” “comprising,” “containing,” “having,” and the like can have the meaning ascribed to them in U.S. patent law and can mean “include(s),” “including,” and the like.

Unless specifically stated or obvious from the context, as used herein, the term “or” is understood to be inclusive.

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present disclosure provides a mixing container for dispensing a powder into a fluid to create a powder-based beverage. In particular, a mixing container stores a beverage powder, dispenses the beverage powder into a liquid, and allows thorough mixing of the dispensed powder. According to an exemplary embodiment, the disclosure may include a cap assembly mechanism and a powdered beverage chamber. Reference will now be made to the drawings, wherein like reference numerals identify similar structural features or aspects of the subject disclosure.

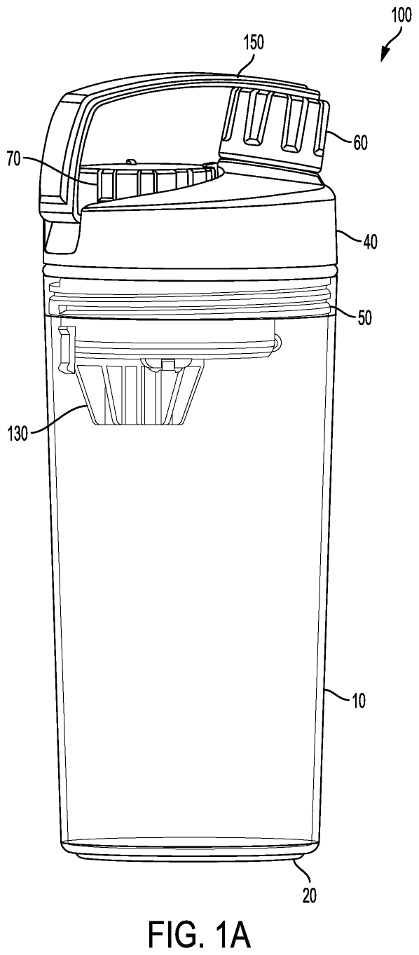

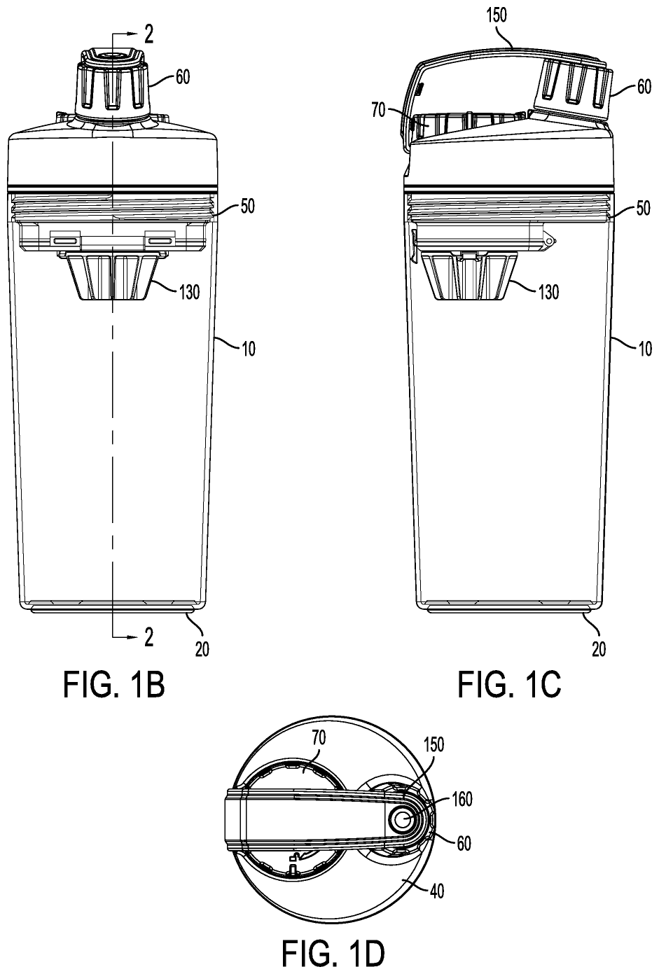

For purposes of explanation and illustration, and not limitation, a perspective view of an exemplary embodiment of a mixing container according to the disclosure is shown in FIG. 1A, and designated generally by reference character 100.

Referring to FIG. 1A, an exemplary embodiment of mixing container 100 is provided. Mixing container 100 may include a bottle 10, a bumper 20, and a cap assembly mechanism 40. Cap assembly mechanism 40 may further include a strap 150, a cap 60, a dial 70, a collar 50, and an agitator 130. Cap assembly mechanism 40 may be removeably connected to bottle 10 via a number of mechanisms including, but not limited to, a threaded connection, a twist lock connection, a snap fit connection, and the like. It is contemplated within the scope of the disclosure that cap assembly mechanism may be used with various containers, bottles, canisters, and the like. Bottle 10 and cap assembly mechanism 40 may be individually constructed (e.g., via known molding techniques), constructed in various combinations, or constructed as a one piece design (e.g., via 3-D printing or other similar molding techniques).

Bottle 10 may be sized to hold a suitable volume of liquid (e.g., 6 oz, 8 oz, 10 oz, 12 oz, 14 oz, 16 oz, 18 oz, 20 oz, 22 oz, 24 oz, 26 oz, 28 oz, 30 oz, 32 oz, or more as desired). In an exemplary embodiment, bottle 10 may be sized to hold 20 oz. One of skill in the art will appreciate that the size of the bottle may be scaled up or down to suit any desired application. Further, bottle 10 may be any suitable container (e.g., a sports bottle, water bottle, or the like).

Mixing container 100 has a generally solid, continuous outer surface that defines an outer perimeter such that a beverage moves around the outer perimeter. Any and all portions of mixing container 100 described herein may be made of any suitable material such as, but not limited to, plastic, metal, ceramic, or combinations thereof. Plastics of the present disclosure may include, for example, polyethylene terephthalate (PET), high density polyethylene, low density polyethylene, vinyl, polypropylene, and polystyrene. Additionally, suitable metals of the present disclosure may include aluminum and iron (e.g., steel, stainless steel, and cast iron). Any seal herein disclosed may be made of any suitable sealing material such as, but not limited to rubber, plastic, soft plastic and/or foam. Bottle 10 may include any suitable shape and design.

Notably, each of these components may be individually constructed (e.g., via known molding techniques), constructed in various combinations, or constructed as a one piece design (e.g., via 3-D printing or by other similar molding techniques).

FIGS. 1B and 1C depict a front and side views, respectively, of mixing container 100. In an exemplary embodiment, agitator 130 may be positioned toward the front of bottle 10, as shown in FIG. 1C.

FIG. 1D depicts a top view of mixing container 100, and in particular, a top view of cap assembly mechanism 40. In one exemplary embodiment, cap assembly 40 may also include strap plug 160.

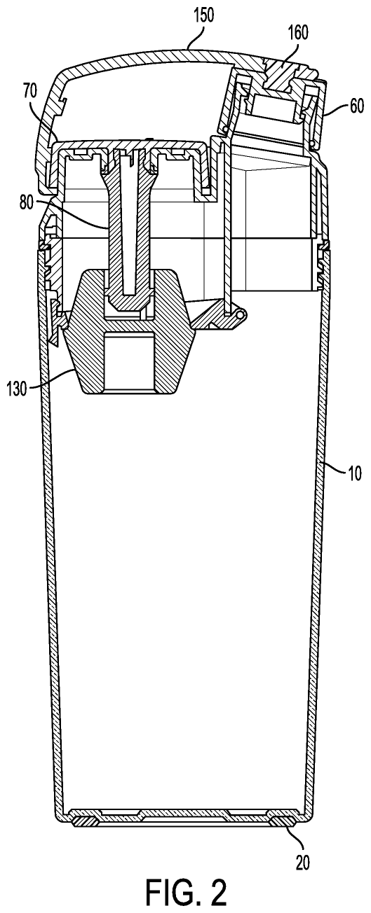

FIG. 2 depicts a cross-sectional view of mixing container 100. As shown in FIG. 2, mixing container 100 may further include agitator retaining post 80.

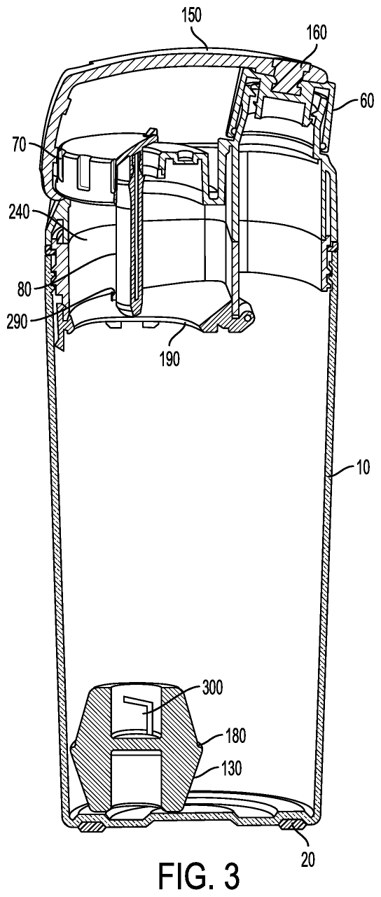

FIG. 3 depicts a cross-sectional view of mixing container 100 the agitator in a deployed position. In an exemplary embodiment, mixing container 100 may contain chamber 240 to store powdered beverage. Chamber 240 may be sized to hold a suitable capacity of powdered beverage (e.g., 6 oz, 8 oz, 10 oz, 12 oz, 14 oz, 16 oz, 18 oz, 20 oz, 22 oz, 24 oz, 26 oz, 28 oz, 30 oz, 32 oz, or more as desired).

Agitator retaining post 80 may also contain agitator retaining latch 290 and sealing lip 190. Agitator 130 may also contain an agitator catch 300. Agitator retaining latch 290 may, in some exemplary embodiments, engage with agitator catch 300. Agitator 130 may additionally contain agitator lip 180. In the deployed position, agitator catch 300 and agitator retaining post 80 are not engaged. In the sealed position, however, agitator catch 300 and agitator retaining post 80 are engaged so as to retain agitator 130 against the bottom side of chamber 240, thereby sealing the bottom portion of chamber 240.

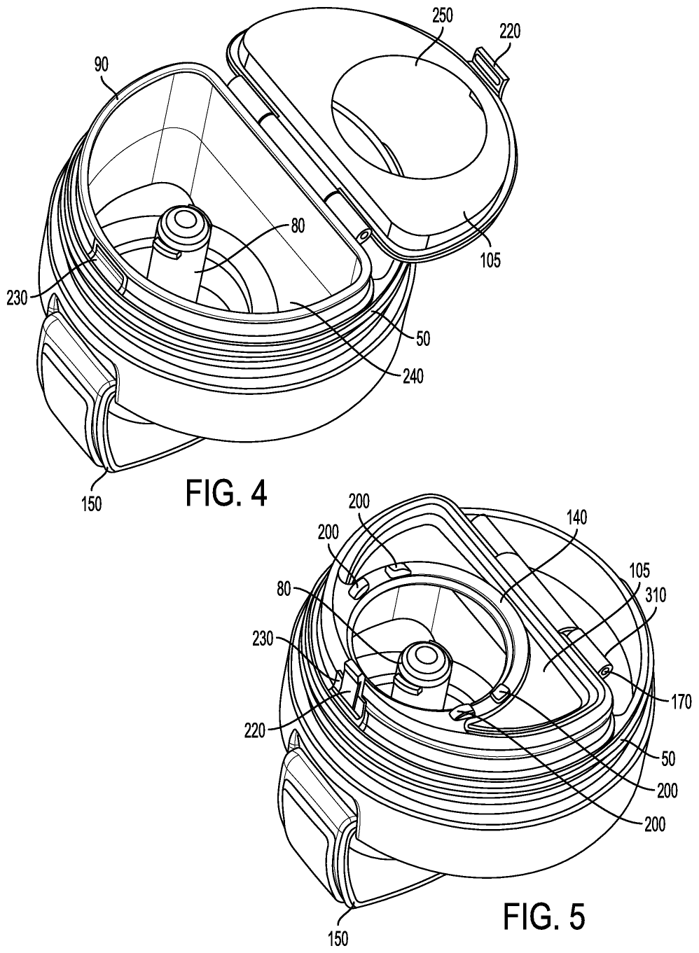

FIG. 4 depicts a bottom perspective view of cap assembly mechanism 40 in which chamber 240 is in an open position. For example, cap assembly mechanism may further include a chamber plate 105, a chamber plate opening 250, a chamber plate gasket 90, a chamber plate latch 220, and collar catch 230. In the open position, a powdered beverage may be added to chamber 240 in any suitable dry volume. Once the powder has been added to chamber 240, agitator 130 may then be affixed to agitator retaining post 80 by a turn of dial 70, thereby sealing the dry powder into chamber 240.

Cap assembly 40 may be connected to bottle 10 to provide a leakproof, resealable connection. Chamber plate gasket 90 may be made of any of a variety of food grade materials such as, for example, rubber, silicone, ethylene propylene diene terpolymer (EPDM), neoprene, and the like. In other embodiments, chamber plate gasket 90 may be a single piece formed from a flexible material, and in some embodiments, multiple materials may be utilized to selectively promote stiffness in some regions and flexibility in other regions of. Chamber plate opening 250 may be of any suitable shape including, but not limited to, a circle, an oval, and an ellipse. Additionally, chamber plate opening 250 may be positioned in any suitable location.

FIG. 5 depicts a bottom perspective view of cap assembly mechanism 40 in a closed position. In the closed position, chamber plate latch 220 and collar catch 230 may be engaged to hold chamber plate 105 in a closed position, so that agitator 130 may be affixed to agitator retaining post 80, thereby allowing agitator 130 to mate with agitator gasket 140 and seal chamber 240 and powdered beverage therein. As clearly seen in FIG. 5, chamber plate 105 may include one or more detents 200. In an illustrative embodiment, detents 200 may be positioned in any suitable position, including, for example, in a direction towards bottle 10. Additionally, detent 200 may be used in a configuration that employs more than one detent 200 per mixing container 100 (e.g., at least 2, at least 3, at least 4). In some embodiments, chamber plate 105 also includes hinge 310 and hinge pin 170. An exemplary embodiment, hinge 310 and hinge pin 170, may function to position chamber plate 105 in either an open or closed position.

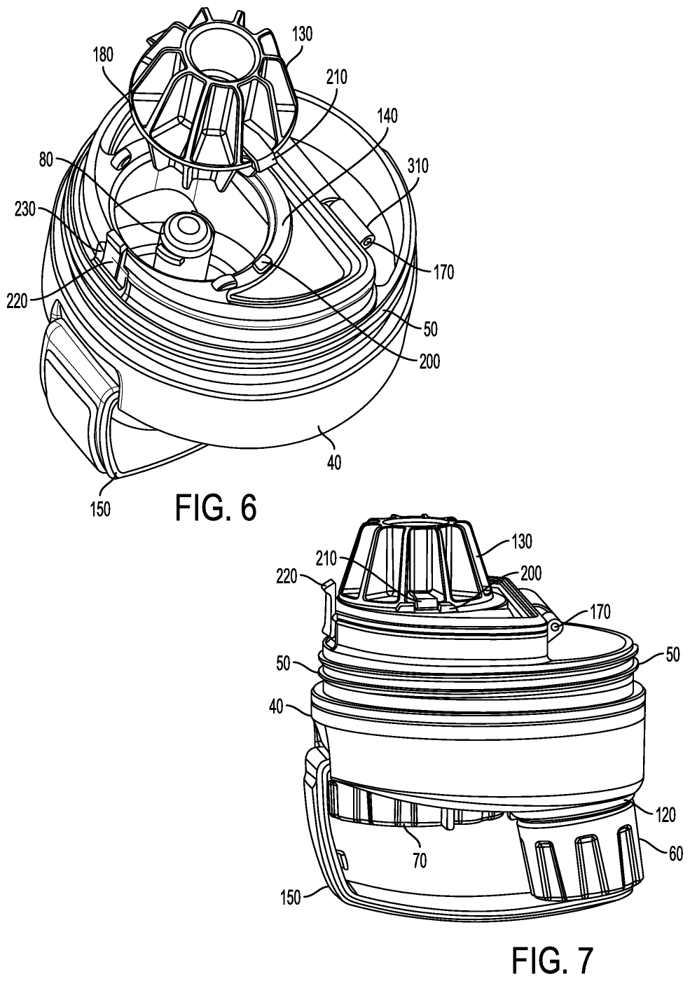

Now referring to FIGS. 6 and 7, a bottom perspective view and an inverted side view of cap assembly 40, respectively, are depicted. As seen in FIGS. 6 and 7, agitator 130 may also include a detent stop 210 and an agitator gasket 140. Detent stop 210 may become engaged with detent 200 in the closed position, as depicted in FIG. 7. Additionally, detent stop 210 may be used in a configuration that employs more than one detent stop 210 per mixing container 100 (e.g., at least 2, at least 3, at least 4).

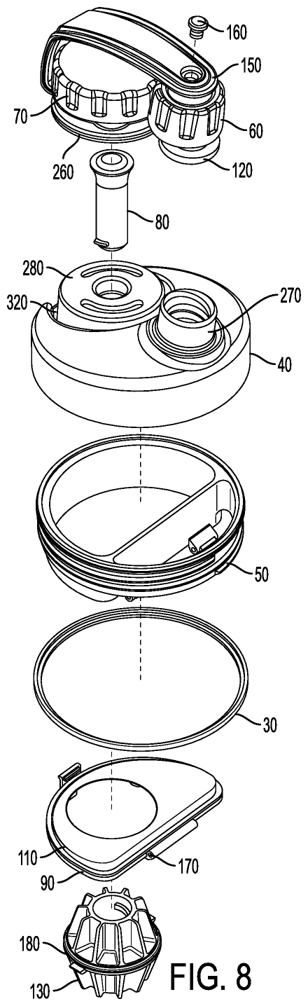

FIG. 8 depicts an exploded view of cap assembly mechanism 40. As is more clearly seen, cap assembly mechanism may further include a gasket 30, a cap gasket 120, a dial gasket 260, a dial bottom 280, a mounting receptacle 320, a spout 330, and a chamber plate gasket 110. Gasket 30, cap gasket 120 (see also FIG. 7), dial gasket 260, and chamber plate gasket 90 may be made of any of a variety of food grade materials such as, for example, rubber, silicone, ethylene propylene diene terpolymer (EPDM), neoprene, and the like. In other embodiments, gasket 30, cap gasket 120, dial gasket 260, and chamber plate gasket 90 may be a single piece formed from a flexible material, and in some embodiments, multiple materials may be utilized to selectively promote stiffness in some regions and flexibility in other regions of. Spout 270 may be configured to be in fluid communication with the internal cavity of bottle 10. It is contemplated within the scope of the disclosure that spout 270 may be made out of any suitable material (e.g., rubber, silicone, and the like).

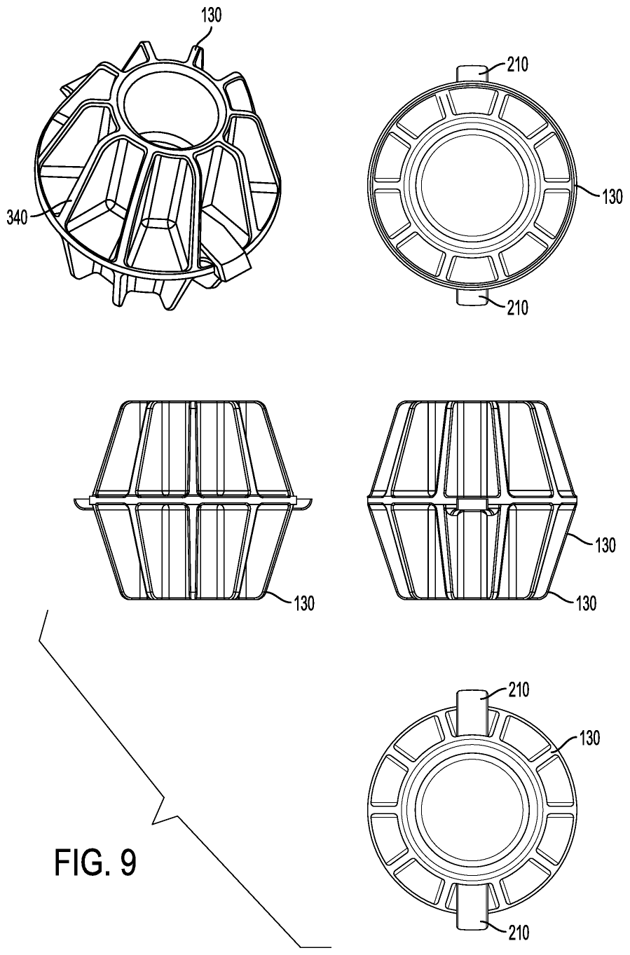

FIG. 9 depicts various views of agitator 130. In particular, agitator 130, in an exemplary embodiment, includes agitator lip 180, detent stop 210, and rib 340. Agitator 130 may be of any suitable shape including, but not limited to, a circle, an oval, and an ellipse. As will be appreciated by one or ordinary skill in the art, the invention provided herein can be fabricated from a variety of materials such as plastic, rubber, metal, and the like by use of various manufacturing techniques such as molding, casting, machining, and the like. For example, components can be formed from polymeric materials such as polypropylene (PP), polyethylene terephthalate (PET), polycarbonate (PC), copolyesters (e.g., PTCG and copolyesters available under the TRITAN™ mark from Eastman Chemical Company of Kingsport, Tenn.), polyphthalate carbonate (PPC), and the like.

### EQUIVALENTS

Although preferred embodiments of the invention have been described using specific terms, such description is for illustrative purposes only, and it is to be understood that changes and variations may be made without departing from the spirit or scope of the following claims.

What is claimed is:

1. A mixing container comprising:
a bottle; and
a cap assembly mechanism including
a spout mounted on a top portion of the cap assembly mechanism,
a chamber positioned within the cap assembly mechanism having a chamber top position and a chamber bottom position, wherein the chamber bottom position includes a chamber opening,
a dial mounted on the top portion of the cap assembly mechanism and positioned proximate to the chamber top position,
an agitator retaining post having a first end and a second end, and
an agitator configured to mate with the chamber opening,
wherein the first end of the agitator retaining post is configured to be attached to a bottom portion of the dial, and the second end of the agitator retaining post is configured to reversibly engage the agitator.

2. The mixing container of claim 1, wherein the agitator seals the chamber when engaged with the second end of the agitator retaining post and mated with the chamber opening.

3. The mixing container of claim 1, wherein the agitator deploys into the bottle when not engaged with the second end of the agitator retaining post, thereby allowing powdered contents of the chamber to come into contact with a fluid in the bottle.

4. The mixing container of claim 3, wherein the deployed agitator mixes the powdered contents into the fluid when the container is shaken.

5. The mixing container of claim 1, wherein the cap assembly mechanism further comprises a strap and a, wherein the strap is configured to mate with an upper portion of the cap.

6. The mixing container of claim 1, wherein a bottom portion of the chamber opening includes an agitator gasket.

7. The mixing container of claim 1, wherein the chamber opening is positioned within a chamber plate that forms the chamber bottom position.

8. The mixing container of claim 7, wherein the chamber plate is configured to be hingedly connected to the cap assembly mechanism.

9. The mixing container of claim 7, wherein the chamber plate includes a latch configured to reversibly couple with a catch positioned on the cap assembly mechanism.

10. The mixing container of claim 1, wherein the agitator includes a plurality of raised ribs positioned vertically around the circumference of the agitator.

11. A method of mixing a powder based drink in the mixing container of claim 1, comprising:
placing a powder in the chamber;
engaging the agitator with the agitator retaining post;
filling the container with a fluid;
releasing the powder into the container by turning the dial to disengage the agitator from the agitator retaining post; and
shaking the container so that the released agitator thoroughly mixes the powder with the fluid.
